(19) United States
(12) Patent Application Publication
(10) Pub. No.: US 2019/0063618 A1
(43) Pub. Date: Feb. 28, 2019

(54) Valve Sleeve for Knife Gate Valve Assembly

(71) Applicant: ICANN Industrial Services Corp., Riverton, UT (US)

(72) Inventor: Kenny J. Guest, Riverton, UT (US)

(73) Assignee: ICANN Industrial Services Corp.

(21) Appl. No.: 15/693,080

(22) Filed: Aug. 31, 2017

(51) Int. Cl. F16K 3/02; F16J 15/02; F16K 3/26

(52) U.S. Cl. CPC F16K 3/0281; F16K 3/265; F16J 15/022

(57) ABSTRACT

A valve sleeve has a seat portion, a flange portion, a wall portion between the seat portion and the flange portion, and a channel defined by an inside surface of the seat portion, flange portion, and wall portion. The sleeve body may be formed of a cast polyurethane material comprising a product of a part-A component isocyanate prepolymer cured with a part-B component curative. The part-A component isocyanate prepolymer comprises a reaction product of a diisocyanate with a polyether polyol, the isocyanate prepolymer having free reactive NCO content ranging from approximately 10% to approximately 20% by weight. The part-B component curative comprises one or more of a glycol and a diamine extender. The valve sleeve formed of the cast polyurethane material has a Shore A hardness ranging from about 50 to about 80 durometer, and a resilience of approximately 30% to approximately 60%, as measured with the Bashore rebound test.

### BACKGROUND INFORMATION

Knife gate valves are used in industrial processes for regulating the flow of materials through pipelines. A knife gate valve assembly typically has a housing body that allows material to flow through a channel in the housing body, and a flat, plate-like gate that uses a reciprocating action to move up and down within the housing body to open or close the channel. To ensure that material does not leak out of the valve, the knife gate valve assembly may also include a valve sleeve. A valve sleeve may be an annular member that is inserted into the channel in the housing body of the knife gate valve assembly. The valve sleeve is used to create a seal within the housing body both when the gate is open as well as when the gate is closed. The valve sleeve may also prevent corrosion of the housing body itself.

However, the reciprocating action of the gate wears out the valve sleeve by cutting into the material of the valve sleeve and chipping away at the valve sleeve. In addition, knife gate valves are often used in mining applications to transport waste tailings and slurries, which frequently contain chemicals and other components that degrade the chemical composition of existing valve sleeves, thus exacerbating the degradation caused by the reciprocating action of the gate. The degradation of a valve sleeve often leads to leakage of material from the knife gate valve, corrosion of the valve assembly, and sometimes complete failure of the knife gate valve. As a result, valve sleeves must be frequently replaced, resulting in significant time and labor costs, as well as operation down time.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements. The drawings are not necessarily drawn to scale, but are drawn to make various features described herein more easily recognizable.

FIG. 1 illustrates a front view of an exemplary reciprocating gate valve assembly according to principles described herein.

FIGS. 2A and 2B illustrate side cross-sectional views of an exemplary knife gate valve assembly according to principles described herein.

FIGS. 3A-3C illustrate various views of an exemplary valve sleeve according to principles described herein.

FIGS. 4A-4C illustrate various views of another exemplary valve sleeve according to principles described herein.

FIGS. 5A-5C illustrate exemplary outer support members according to principles described herein.

FIG. 6 illustrates another exemplary outer support member according to principles described herein.

FIG. 7 illustrates an exemplary plurality of outer support members according to principles described herein.

FIG. 8 depicts an exemplary method of making a valve sleeve according to principles described herein.

FIG. 9 depicts another exemplary method of making a valve sleeve according to principles described herein.

### DETAILED DESCRIPTION

A valve sleeve for sealing a knife gate valve assembly may include a sleeve body having a seat portion provided at an inner portion of the valve sleeve, a flange portion provided at an outer portion of the valve sleeve, a wall portion provided between the seat portion and the flange portion, and a channel defined by an inside surface of the seat portion, the flange portion, and the wall portion. The sleeve body may be formed of a cast polyurethane material comprising a product of a part-A component isocyanate prepolymer cured with a part-B component curative. The part-A component isocyanate prepolymer may be a reaction product of a diisocyanate with a polyether polyol, the part-A component isocyanate prepolymer having free reactive NCO content ranging from about 5% to about 24%, preferably from about 10% to about 20%, more preferably from about 13% to about 16%, and even more preferably from about 14% to about 15%. The part-B component curative may comprise one or more of a glycol and a diamine extender. The cast polyurethane material may have a Shore A hardness ranging from about 50 to about 80 durometer, preferably from about 60 to about 75 durometer, and more preferably from about 65 to about 70 durometer. The cast polyurethane material may have a resilience of about 30% to about 60%, preferably from about 40% to about 55%, and more preferably from about 45% to about 50%, as measured with a Bashore rebound test.

As will be described below in more detail, valve sleeves formed of the cast polyurethane material described herein have greater resistance to degradation of the valve sleeves caused by water, chemicals, and other constituents of slurries and materials that typically pass through the valve sleeves. In addition, the valve sleeves formed of the cast polyurethane material have improved hardness and resilience that enable smooth action of the knife gate and reduce wear and tear on the valve sleeve and significantly increase the longevity of the valve sleeves as compared with conventional valve sleeves. Furthermore, the valve sleeves formed of the cast polyurethane material are easy to process and manufacture. These and other advantages will be evident in light of the following disclosure.

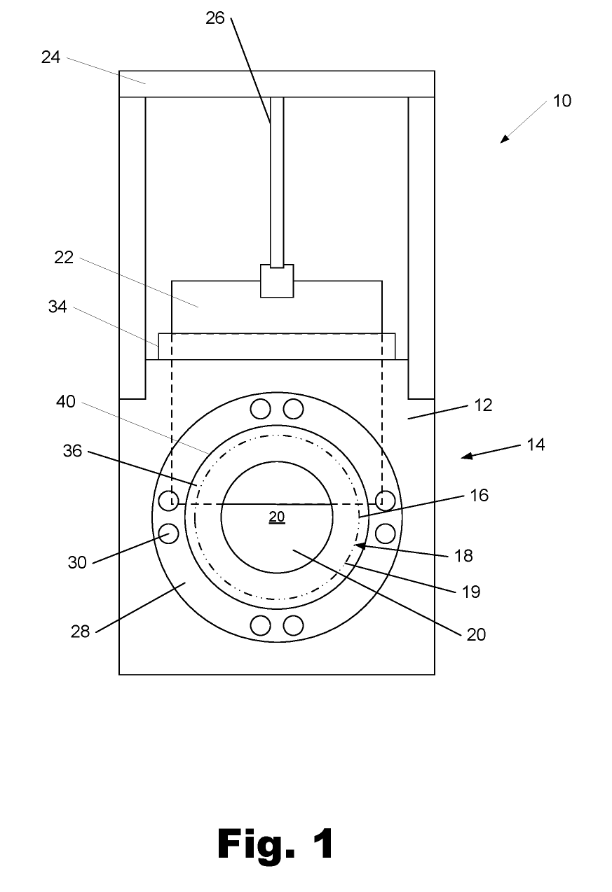

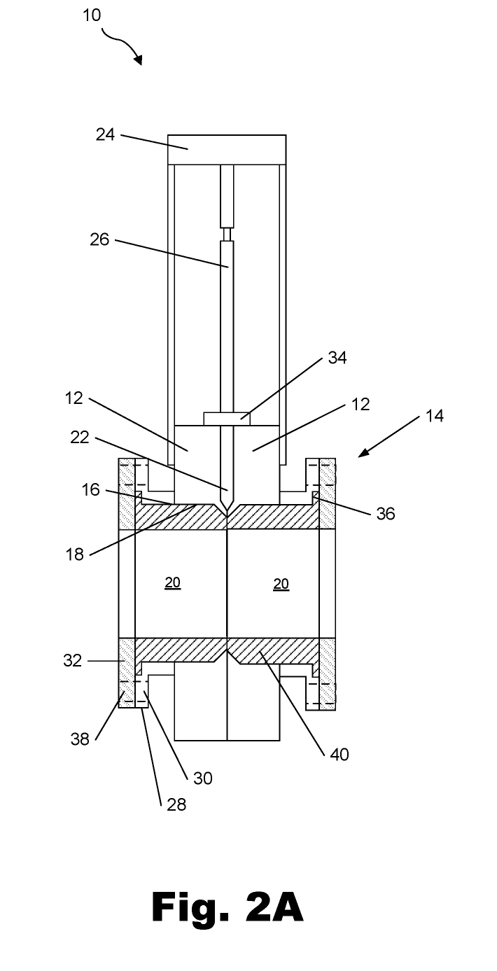

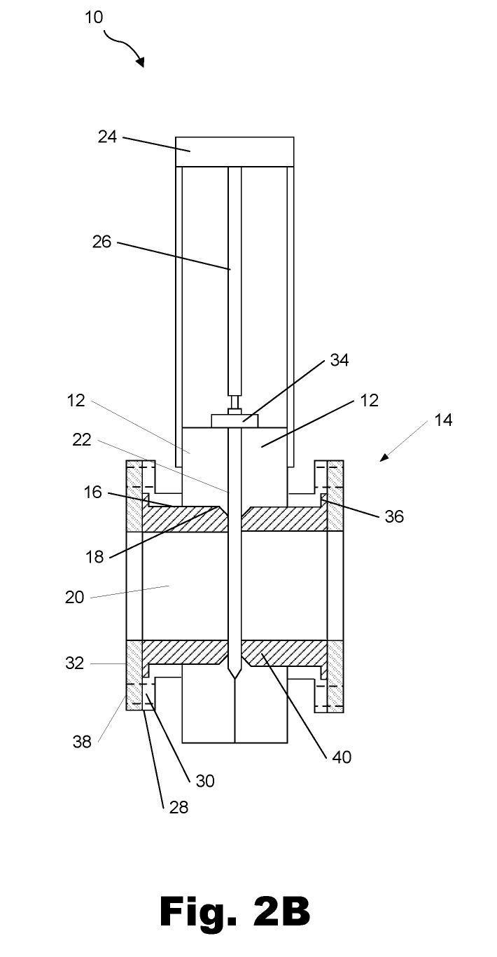

An exemplary knife gate valve assembly in which the valve sleeve may be used will first be described with reference to FIGS. 1, 2A, and 2B. Knife gate valve assembly 10 may include two housing plates 12 joined together by bolts or other fasteners (not shown) to form valve housing 14. Alternatively, housing body 14 may be formed of a unitary body in which housing plates 12 are formed integrally with one another. Each housing plate 12 may have an opening 16, and an inside surface 18 of opening 16 in each housing plate 12 defines a sleeve channel 19 for receiving valve sleeve 40. As illustrated in FIGS. 2A and 2B, valve sleeve 40 may fit in the sleeve channel, and when the two housing plates 12 are joined together, the axially aligned valve sleeves 40 abut against each other to define a continuous, uninterrupted channel 20 through housing 14.

Knife gate valve assembly 10 further includes a gate for controlling the flow of material through channel 20. For example, gate 22 may comprise a plate-like member that reciprocates within housing 14 to open and close channel 20. When gate 22 is in an open position, gate 22 may be positioned in valve housing 14 above channel 20 to permit the free flow of material through channel 20. When gate 22 closes, gate 22 moves downward between the abutting valve sleeves 40 until gate 22 has fully blocked channel 20. Due to the elasticity of valve sleeves 40, gate 22 pushes a portion of each valve sleeve 40 away from gate 22 as gate 22 moves downward, thereby enabling gate 22 to pass between abutting valve sleeves 40. When gate 22 has stopped moving and is in a fully closed position, the resilience of each valve sleeve 40 causes each valve sleeve 40 to press tightly against gate 22, thereby creating a seal against gate 22 to prevent the leakage of material from between gate 22 and valve sleeve 40.

The reciprocating action of gate 22 may be actuated by an actuator 24 connected to gate 22 by way of stem 26. Actuator 24 may be any type of automatic or manual actuator, including but not limited to pneumatic, hydraulic, electric, or mechanical. While FIGS. 1, 2A, and 2B show knife gate valve assembly 10 positioned in an upright position in which gate 22 moves up and down, such depiction is only exemplary, and knife gate valve assembly 10 may be positioned horizontally or in any other orientation as may be necessary or convenient.

Each housing plate 12 may also include a connection flange 28 for connection of knife gate valve assembly 10 to a pipeline (not shown). Connection flange 28 may comprise a protruding portion that protrudes from a housing plate 12 to allow a flange end of a pipeline to be attached by bolts or other fasteners. For example, as shown in FIG. 1, connection flange 28 may surround opening 16 in housing plate 12 and may include one or more holes 30 that align with holes on the flange end of the pipeline. Knife gate valve assembly 10 may be installed in a pipeline by axially aligning the pipeline channel with channel 20 defined by valve sleeve 40 and securing connection flange 28 of housing plate 12 to the flange end of the pipeline with bolts through the axially aligned holes.

A retainer flange may be inserted between connection flange 28 of housing plate 12 and the flange end of the pipeline to act as a gasket to provide a seal at the connection between the pipeline and housing plate 12. For example, retainer flange 32 may comprise an annular member having an outer shape and size similar to a shape and size of the flange end of the pipeline and/or the shape and size of connection flange 28 of housing plate 12. Retainer flange 32 may have an internal diameter roughly equivalent to an internal diameter of valve sleeve 40 and the pipeline channel, thereby allowing material to flow freely through retainer flange 32 while providing a seal at the junction between knife gate valve assembly 10 and the pipeline.

Knife gate valve assembly 10 may further include a wiper that wipes material off the face of gate 22 as gate 22 reciprocates between open and closed positions. For example, wiper 34 may comprise a frame-like member having an opening substantially similar in size and shape to a cross-sectional shape of gate 22, and may be fitted tightly against the opposing faces of gate 22 in order to wipe material off gate 22. Wiper 34 may be positioned, for example, on the top portion of each housing plate 12. Thus, when gate 22 moves downward from an open position to a closed position, wiper 34 blocks any foreign matter from outside valve housing 14 that may have accumulated onto gate 22 from entering into channel 20 or into the space between abutting valve sleeves 40. Similarly, as gate 22 moves upward from the closed position to the open position, wiper 34 prevents any material flowing through channel 20 from adhering to the plate and passing to the outside of the valve housing 14. In this way, wiper 34 prevents degradation of valve sleeve 40 and ensures smooth operation of knife gate valve assembly 10.

Additionally or alternatively to wiper 34, knife gate valve assembly 10 may include a secondary seal assembly (not shown) that lubricates gate 22 and prevents material from discharging through the top of housing 14 and entering into channel 20. Knife gate valve assembly 10 may also include one or more gaskets (not shown) disposed between joined housing plates 12 to ensure a tight connection and prevent leakage from housing 14.

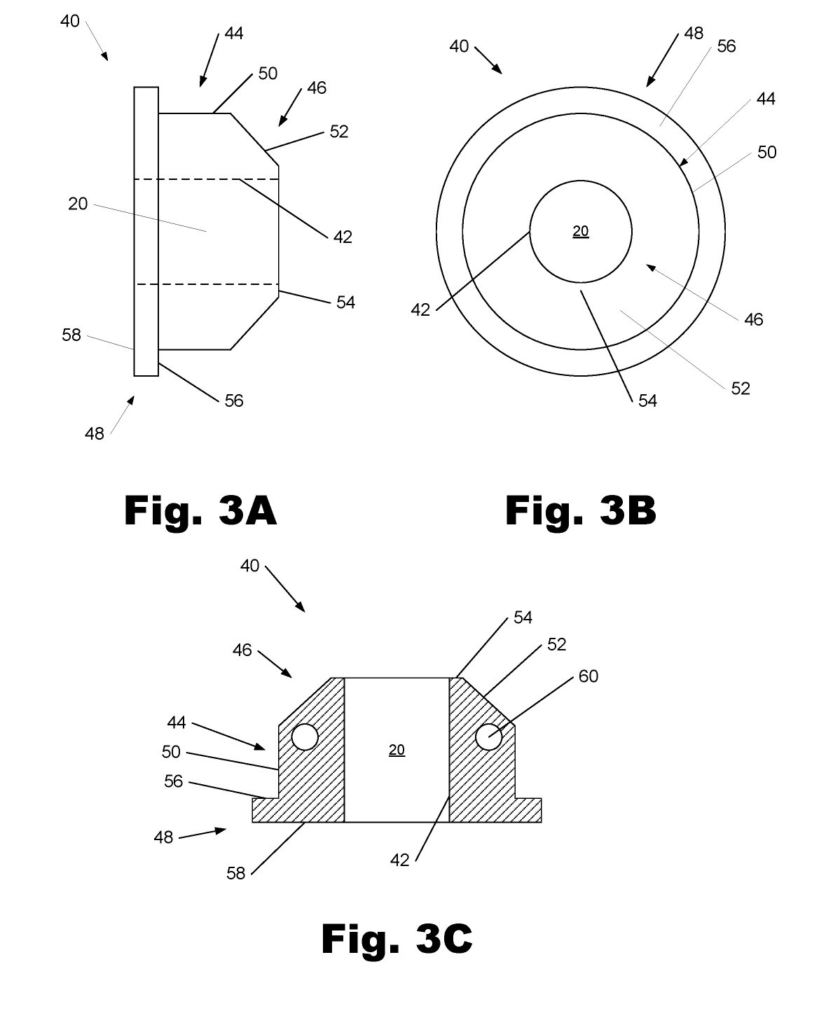

Valve sleeve 40 will now be described in detail with reference to FIGS. 3A-3C. As shown, valve sleeve 40 may be an annular member having an opening that defines channel 20. Valve sleeve 40 may be configured to fit into sleeve channel 19 of a housing plate 12. Valve sleeve 40 may include wall portion 44, seat portion 46, and flange portion 48, all surrounding channel 20.

Wall portion 44 may comprise the portion of valve sleeve 40 that is disposed between seat portion 46 at an inner portion of valve sleeve 40, and flange portion 48 disposed at an outer side of valve sleeve 40. As used herein, an “inner portion” or “inner end” of valve sleeve 40 refers to a portion of valve sleeve 40 that is closer to gate 22 when valve sleeve 40 is installed in sleeve channel 19 of housing plate 12, as compared with an “outer portion” or “outer end” of valve sleeve 40, which is farther from gate 22 than the inner portion when valve sleeve 40 is installed in sleeve channel 19 of housing plate 12.

Outside surface 50 of wall portion 44 may be shaped to match sleeve channel 19 of housing plate 12. For example, in some knife gate valve assemblies, inside surface 18 of opening 16 in housing plate 12 may include a small groove or channel extending circumferentially around opening 16. Therefore, valve sleeve 40 may include a corresponding protruding part (not shown) that protrudes radially from outside surface 50 of wall portion 44 and extends circumferentially around wall portion 44, thereby allowing valve sleeve 40 to “lock” into opening 16 of housing plate 12.

Seat portion 46 of valve sleeve 40 may be disposed at the inner portion of valve sleeve 40. Seat portion 46 may include an outside surface 52 that forms a continuous surface with outside surface 50 of wall portion 44. Seat portion 46 may further include a seat 54, which is a surface portion formed between outside surface 52 of seat portion 46 and inside surface 42 of channel 20. Thus, seat 54 may include a surface in a plane that is orthogonal to an axial direction of channel 20 (or parallel to a plane of gate 22). For example, when valve sleeve 40 is inserted in a housing plate 12 that is joined with another housing plate 12 to form valve housing 14, seat 54 of a first valve sleeve 40 abuts against seat 54 of the opposite valve sleeve 40 when gate 22 is in an open position, and abuts against gate 22 when gate 22 is in a closed position.

Seat portion 46 may be tapered or chamfered toward channel 20 in a direction moving from wall portion 44 toward seat 54 in order to allow the tip end of gate 22 to more easily slide between abutting valve sleeves 40 without cutting into valve sleeves 4, and to push the material of seat portion 46 and/or wall portion 44 back to allow gate 22 to squeeze between the abutting valve sleeves 40 without damaging valve sleeves 40.

Flange portion 48 may be formed at an outer portion of valve sleeve 40 to enable valve sleeve 40 to connect to a pipeline. An outside diameter of flange portion 48 may generally be larger than an outside diameter of wall portion 44, when viewed in plan view, thereby forming a flange shelf portion 56 having a surface that is substantially orthogonal to an axial direction of channel 20. Flange shelf portion 56 may be shaped and configured to match and fit within a recess 36 formed in housing plate 12 around opening 16 (see FIGS. 1, 2A, and 2B), thereby securing valve sleeve 40 at the appropriate location within valve sleeve 40 channel. End face 58 of flange portion 48 may be provided at the outer end of valve sleeve 40, and generally has a surface that extends in a plane that is substantially orthogonal to an axial direction of channel 20. A diameter of channel 20 at flange end face 58 corresponds to an internal diameter of valve sleeve 40 and an internal diameter of a connected pipeline.

End face 58 of flange portion 48 abuts against retainer flange 32 when valve sleeve 40 is inserted in the valve housing 14 and retainer flange 32 is secured to connection flange 28 to connect housing 14 to a pipeline. Retainer flange 32 abuts against end face 58 of flange portion 48 and may be secured to connection flange 28 of housing plate 12, thereby securing valve sleeve 40 in place in opening 16 of housing plate 12 and providing a seal between valve sleeve 40 and retainer flange 32. Retainer flange 32 may include holes 38 that align with holes 30 in connection flange 28 of housing plate 12 and holes in a flange end of the pipeline (not shown) for bolts or other fasteners to secure the pipeline and retainer flange 32 to housing plate 12.

Valve sleeve 40 may include one or more support members disposed within the body of valve sleeve 40 to provide strength and support to valve sleeve 40 and to facilitate opening and closing of gate 22 without damage to valve sleeve 40. For example, as shown in FIG. 3C, valve sleeve 40 may include inner support member 60 disposed at an inner portion of valve sleeve 40. In one embodiment, inner support member 60 may be disposed inside wall portion 44. Alternatively, inner support member 60 may be disposed inside seat portion 46.

Regardless of location, inner support member 60 may be a rigid annular member that is disposed in a plane orthogonal to an axial direction of channel 20. Inner support member 60 helps seat portion 46 of valve sleeve 40 move away from gate 22 when gate 22 closes. For instance, when gate 22 begins to close, it first comes into contact with the top edge of seat portion 46, pushing the top edge of seat portion 46 away from gate 22 in a direction orthogonal to the plane in which gate 22 moves. If valve sleeve 40 did not have inner support member 60, only the region of seat portion 46 near where gate 22 contacts seat portion 46 would be displaced by the action of gate 22, thus applying significant amounts of shear stress on valve sleeve 40 and often resulting in early failure of the valve sleeve. However, when valve sleeve 40 includes inner support member 60, the closing action of gate 22 pushes the leading edge of inner support member 60 away from gate 22, which pulls the entire seat portion 46 away from gate 22. This action of inner support member 60 helps separate abutting valve sleeves 40 and prevents gate 22 from cutting into the material of seat portion 46, thus prolonging the life of valve sleeve 40.

Inner support member 60 may comprise an annular rigid body having an outside diameter that is less than an outside diameter of valve sleeve 40 at wall portion 44 or seat portion 46, depending on the location of inner support member 60. The rigid body may have any cross sectional shape, such as circular, oval, rectangular, or any other polygon. For example, as shown in FIG. 3C, inner support member 60 may have a circular cross sectional shape. For valve sleeves 40 for nominal pipe sizes in the range of 2 inches up to about 24 inches, inner support member 60 generally has a cross-sectional diameter larger than about one-eighth (⅛) inch, preferably larger than about one-fourth (¼) inch, and more preferably ranging from about one-fourth (¼) inch up to about one-half (½) inch. When inner support member 60 is configured with this thickness, inner support member 60 provides increased strength and durability as compared with smaller support members in conventional devices. Nevertheless, it should be appreciated that other sizes may be used as may serve a particular implementation.

As explained above, inner support member 60 may be positioned within valve sleeve 40 in a position toward seat 54. Positioning inner support member 60 too close to seat 54 may result in tearing and cutting from gate 22, while positioning inner support member 60 too far from seat 54 may prevent inner support member from facilitating movement of gate 22. According to at least one embodiment, therefore, a center of inner support member 60 may be positioned in valve sleeve 40 approximately 0.5 inches up to approximately 1.5 inches from a surface of seat 54 that contacts gate 22 or an abutting valve sleeve 40, as measured in an axial direction of channel 20, depending on a size of valve sleeve 40 in the axial direction. In addition, Table 1 below provides exemplary measurements for the center of inner support member 60 for valve sleeves configured for certain nominal pipe sizes, and also provides measurements for an outside diameter of inner support member 60 and a cross-sectional diameter of inner support member 60. These measurements are not intended to be limiting, but are merely illustrative, as the measurements may be varied as needed to serve a particular implementation.

TABLE 1

| | Cross-Sectional | | Outside |
|---|---|---|---|
| NPS | Diameter | Distance | Diameter |
| (inches) | (inches) | (inches) | (inches) |
| 2 | 0.25 | 0.50 | 2.8 |
| 3 | 0.25 | 0.51 | 3.9 |
| 4 | 0.25 | 0.55 | 4.9 |
| 6 | 0.375 | 0.60 | 7.0-7.25 |
| 8 | 0.375 | 0.80 | 8.65-9.15 |
| 10 | 0.375 | 0.86 | 10.9-11.15 |
| 12 | 0.375 | 0.915 | 12.6-13.6 |
| 14 | 0.375 | 0.93 | 14.5-14.75 |
| 16 | 0.50 | 1.0 | 16.1-16.95 |
| 18 | 0.50 | 1.025 | 17.4-19.46 |
| 20 | 0.50 | 1.45 | 19.2-21.5 |
| 24 | 0.50 | 1.2 | 23.4-25.72 |

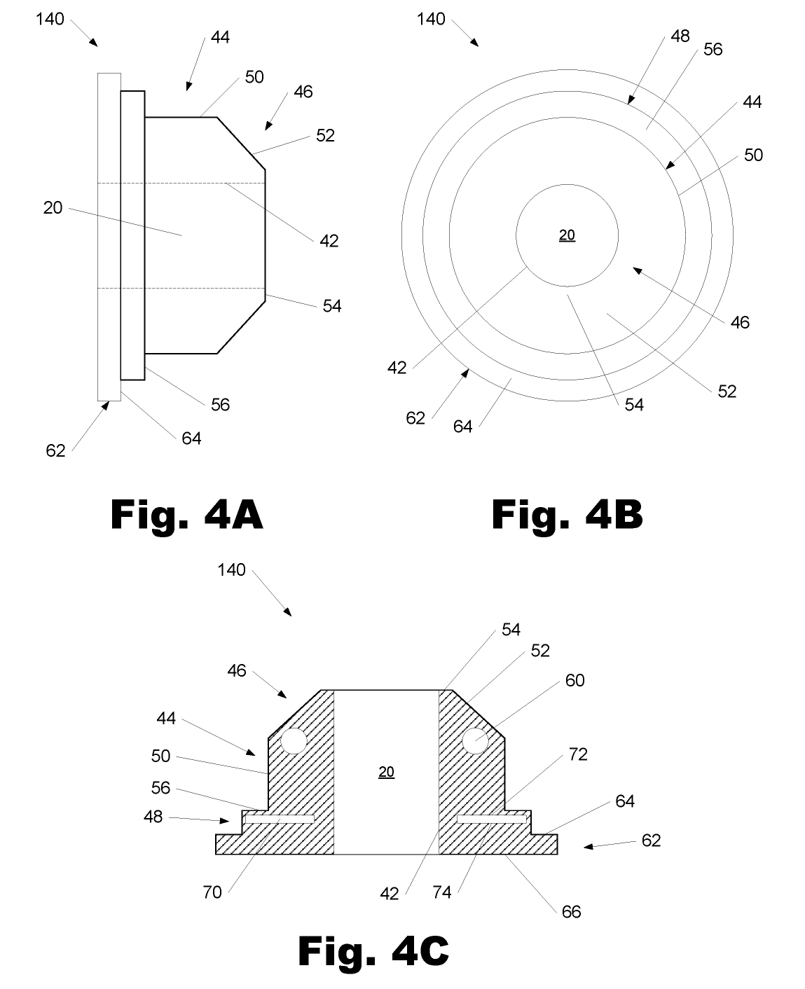

Referring now to FIGS. 4A-4C, another exemplary embodiment of a valve sleeve is illustrated. The same or similar components as those in the embodiment shown in FIGS. 3A-3C are denoted by the same reference numerals, and a repeated description will be omitted. Valve sleeve 140 may include gasket portion 62 positioned further to the outer end of valve sleeve 140 than flange portion 48. An outside diameter of gasket portion 62 may be larger than an outside diameter of flange portion 48, thereby forming a gasket shelf portion 64 on a surface substantially orthogonal to an axial direction of channel 20. When valve sleeve 140 is installed in housing plate 12, gasket shelf portion 64 may abut against connection flange 28 on a front face of housing plate 12. With this configuration, gasket portion 62 eliminates the need for a retainer flange between housing 12 and a pipeline end flange. Instead, end face 66 of gasket portion abuts against a pipeline end flange, thereby creating a seal between the pipeline and valve sleeve 140.

Valve sleeve 140 may include one or more support members disposed within the body of valve sleeve 40 to provide strength and support to valve sleeve 140. For example, valve sleeve 140 may include, in addition to, or in place of, inner support member 60, an outer support member disposed toward the outer end of valve sleeve 140. For example, as shown in FIG. 4C, valve sleeve 140 may include outer support member 70. Outer support member 70 may be a rigid annular member that is disposed in a plane parallel to a plane in which gate 22 moves.

Outer support member 70 provides stiffness and rigidity to the outer end of valve sleeve 140 to ensure that end face 66 remains pressed tightly against a pipeline end flange, thus preventing leakage at the joint between a pipeline end flange and valve sleeve 140.

Outer support member 70 may be located at any location within valve sleeve 140 that is on an outer end side of inner support member 60. In one exemplary embodiment, outer support member 70 may be disposed within flange portion 48. Alternatively, outer support member 70 may be disposed within gasket portion 62. Preferably, at least a portion of outer support member 70 is overlapped by flange shelf portion 56. In conventional valve sleeves, an outer support member is positioned within a flange portion or a gasket portion such that the outer support member is closer to an end face of the valve sleeve than to a flange shelf portion surface. However, under high pipeline pressure the outer support member bends and twists in the plane of the outer support member, thus pulling portions of gasket portion away from the pipeline end flange, resulting in leaks and further degrading the structure of valve sleeve.

To prevent these and other problems, outer support member 70 of the present embodiment may be disposed within flange portion 48 such that outer support member 70 is positioned closer to flange shelf portion 56 than to end face 66. For example, a distance between outer support member 70 and flange shelf portion 56 is smaller than a distance between outer support member 70 and end face 66. According to this configuration, there is a greater amount of elastomeric material in flange portion 48 and gasket portion 62 between outer support member 70 and end face 66 to elastically deform under high pressure, thus preventing bending and twisting of outer support member 70 and maintaining a tight seal with a pipeline end flange. Table 2 below provides exemplary measurements for the position of outer support member 70 for valve sleeves configured for certain nominal pipe sizes. All measurements are from seat 54 in the axial direction. These measurements are not intended to be limiting, but are merely illustrative, as the measurements may be varied as needed to serve a particular implementation.

TABLE 2

| NPS | Distance |
|---|---|
| (inches) | (inches) |
| 2 | 0.8 |
| 3 | 0.82 |
| 4 | 0.86 |
| 6 | 0.98 |
| 8 | 1.375 |
| 10 | 1.25 |
| 12 | 1.4 |
| 14 | 1.335 |
| 16 | 1.55 |
| 18 | 1.55 |
| 20 | 2.18 |
| 24 | 1.865 |

To further ensure that outer support member 70 does not bend or twist, a thickness of outer support member 70 may be larger than about one-eighth (⅛) of an inch. More preferably, a thickness of outer support member 70 may be approximately three-sixteenths ( 3/16) of an inch or greater and less than one-half (½) of a thickness of flange portion 48 (i.e., one-half (½) of a thickness from gasket shelf portion 64 to flange shelf portion 56). Outer support member 70 may be formed of any rigid material, including, but not limited to, carbon steel, alloy steel, and aluminum.

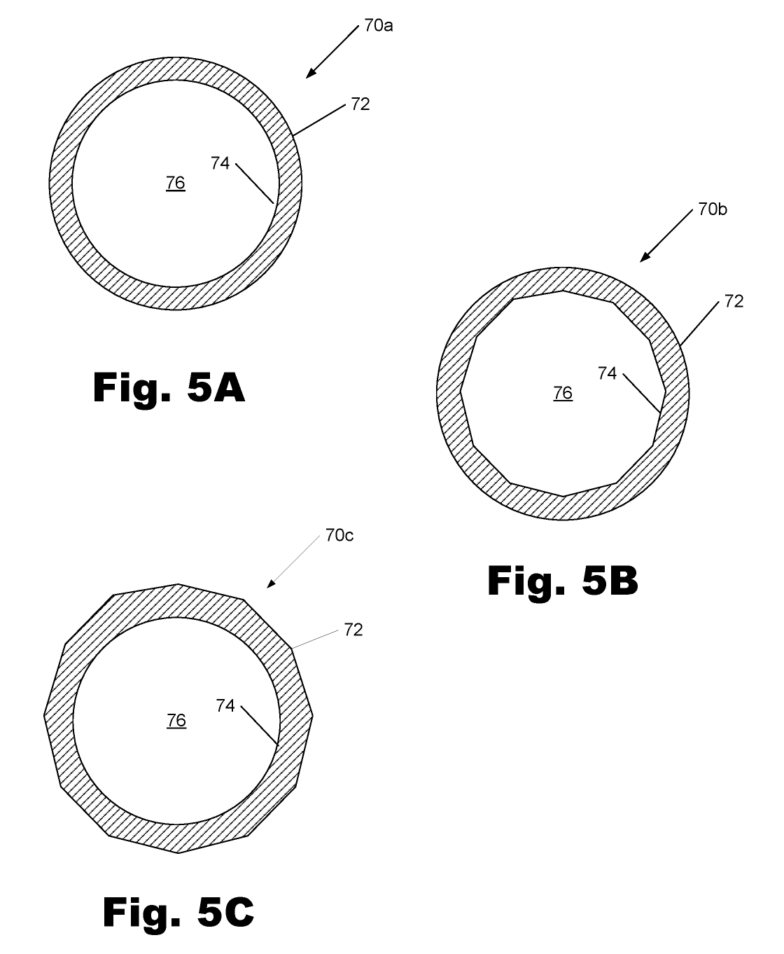

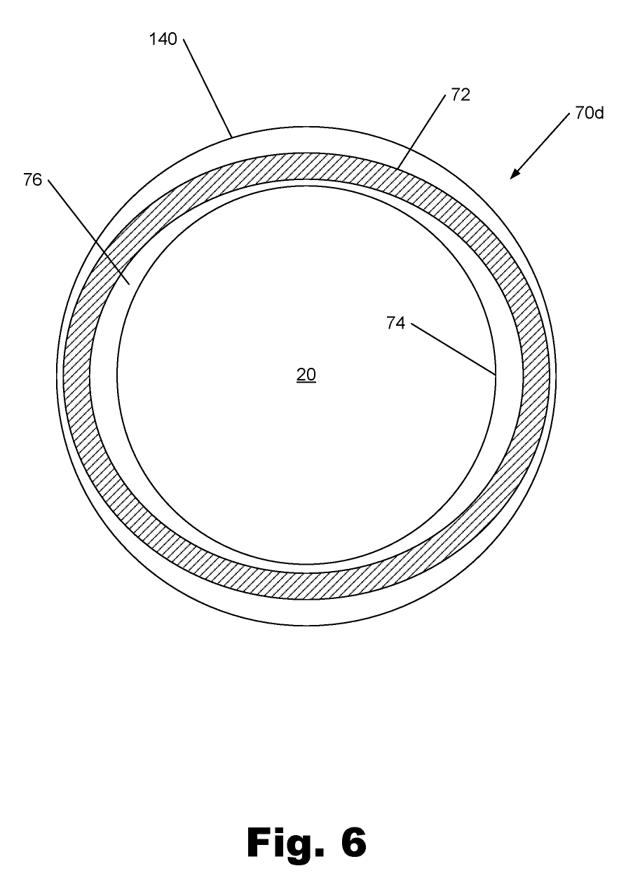

As explained above and as shown in FIGS. 5A-5C and FIG. 6, outer support member 70 (e.g., outer support members 70a, 70b, 70c, and 70d) may comprise a solid, substantially annular member disposed within valve sleeve 140 so as to surround channel 20. Outer support member 70 has outside edge 72 and inside edge 74 defining opening 76, which corresponds to channel 20 when outer support member 70 is disposed in valve sleeve 140. The solid configuration of outer support member 70 provides substantial strength and rigidity that is often necessary for high pressure applications and to distribute the load on valve sleeve 140.

As shown in FIG. 5A, outer support member 70a may have a shape substantially similar to a shape of valve sleeve 140, when viewed in plan view (i.e., a view in an axial direction of channel 20). For example, when valve sleeve 140 has a circular shape, outside edge 72 and inside edge 74 each have a substantially circular shape such that outer support member 70a comprises a solid, ring-shaped member.

Alternatively, outside edge 72, inside edge 74, or both may have a shape, as viewed in plan, view that is different than a shape of valve sleeve 140. As will be explained below in more detail, outer support member 70 having outside edge 72, inside edge 74, or both, that differs from a shape of valve sleeve 140 allows gas to escape at various locations during molding and formation of valve sleeve 140.

For example, as shown in FIG. 5B, outer support member 70b may have a solid body surrounding opening 76, outside edge 72 may have a substantially circular shape, and inside edge 74 may have a substantially polygonal shape. During production of valve sleeve 140, gas may escape from the polyurethane resin at regions near the vertices of the polygon. While the exemplary embodiment of FIG. 5B shows that inside edge 74 of outer support member 70b forms a polygon having twelve sides, outer support member 70b is not limited to this configuration. Inside edge 74 may form a polygon having any number of sides, ranging from three (e.g., a triangle) up to twelve or more. As shown in FIG. 5C, outer support member 70c may have a solid body surrounding opening 76, outside edge 72 may have a substantially polygonal shape, and inside edge 74 may have a substantially circular shape. With this configuration, gas may escape from the polyurethane resin at regions between the vertices of the polygon. It should be appreciated that inside edge 74 and/or outside edge may not form a polygon, but may be any irregular shape, and may be formed of straight and/or curved edges.

As shown in FIG. 6, outer support member 70d may substantially be in the shape of an ellipse or oval, and thus have a shape different from a shape of valve sleeve 140. With this configuration, gas may be able to escape from the polyurethane resin at regions near the vertices and the co-vertices of the ellipse or oval during production of valve sleeve 140.

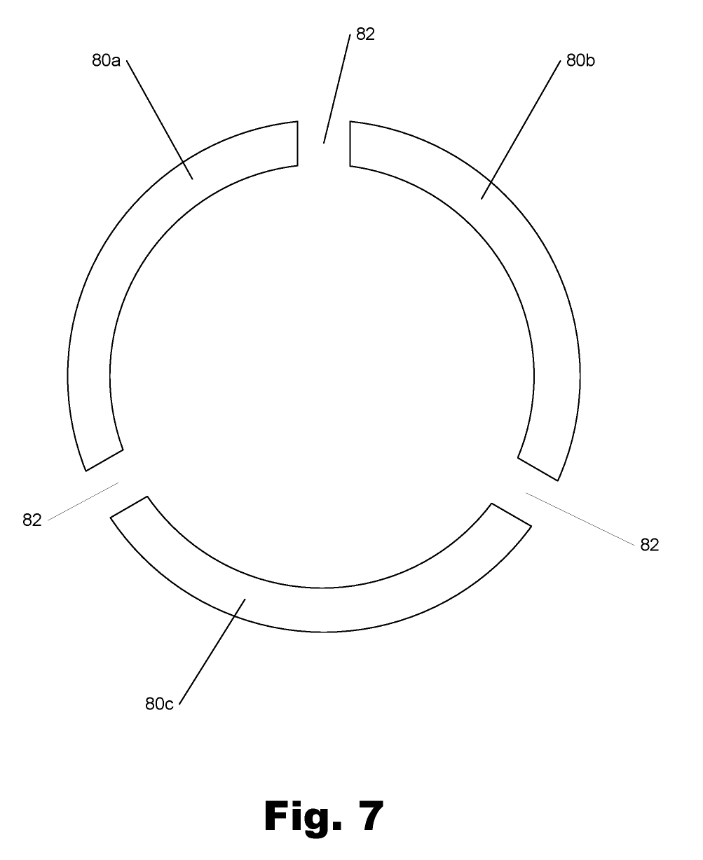

Alternatively to outer support member 70, valve sleeve 140 may include a plurality of outer support members configured to provide strength and rigidity to flange portion 48 and/or gasket portion 62 while allowing gas to escape during formation. For example, as shown in FIG. 7, outer support members 80 may include first support member 80a, second support member 80b, and third support member 80c. As shown, each support member 80 may comprise a segment that extends over less than a circumference of valve sleeve 140. For example, as shown in FIG. 7, support members 80 may each comprise approximately one-third of a circular or polygonal shape. Support members 80 may be arranged in valve sleeve 140 with gaps between adjacent support members 80 such that adjacent support members 80 do not contact, and are not connected to, each other. For example, in some embodiments outer support members 80 may be disposed in a same plane such that gaps 82 are disposed between adjacent outer support members 80 in the plane. In another embodiment (not shown), outer support members 80 may be formed in different planes such that adjacent outer support members overlap one another, with gaps between the adjacent planes. Accordingly, gas may escape through the gaps during molding and formation of valve sleeve 140. By using a plurality of outer support member 80, production costs can be significantly reduced since more outer support members 80 can be formed from a single sheet of metal than completely circular support members, as with outer support members 70a, 70b, and 70c shown in FIGS. 5A-5C.

While FIG. 7 shows three outer support members 80, the number of outer support members 80 may be any number of two or more support members, as may serve a particular implementation. Furthermore, while outer support members 80 are shown as having a curved, arc shape, outer support members 80 may have any other shape. For example, outer support members 80 may be straight segments of a polygon arrangement when arranged around channel 20 of valve sleeve 140, thus allowing release of gas not only in the gaps but also at the polygon vertices during molding and production of valve sleeve 140.

Additionally or alternatively, when retainer flange 32 is used in the connection between valve housing 14 and a pipeline end flange (see, e.g., FIGS. 2A and 2B), retainer flange 32 may also include one or more outer support members to help strengthen retainer flange 32. For example, retainer flange 32 may include any of the outer support members herein, such as outer support members 70a, 70b, 70c, and 80.

Wall portion 44, seat portion 46, and flange portion 48, and optionally gasket portion 62 when provided in the valve sleeve, may comprise a single body formed of a homogeneous elastomeric material. Conventional valve sleeves are generally formed of natural rubber, gum rubber, EPDM rubber (ethylene propylene diene monomer (M-class)), EPM rubber (ethylene propylene rubber), nitrile rubbers (e.g., NBR and Buna-N rubber), and fluoroelastomers. However, these materials exhibit significant drawbacks when used in knife gate valves. For example, valve sleeves made of gum rubber and fluoroelastomers do not have good tolerance for chemicals, such as bases, and degrade quickly in the presence of these chemicals. Nitrile rubbers do not have good flexibility at lower temperatures, resulting in less movement in the seat portion when the gate opens and closes. As a result, the gate can cut into the nitrile rubber material at the seat portion, quickly damaging the valve sleeve and reducing the total life of the valve sleeve. Other elastomers used in conventional valve sleeves have poor hydrolytic stability, resulting in quick degradation of the valve sleeves when used in water-based systems, such as slurries.

To address these and other problems, the valve sleeve according to the present disclosure may be formed of a cast polyurethane material that exhibits an improved combination of wear resistance, hardness, and resilience. The improved wear resistance of polyurethane allows the valve sleeve to be used in a variety of applications where improved resistance to degradation from chemicals and slurry material is required. The improved hardness and resilience ensure that seat portion 46 of valve sleeve 40 maintains a tight seal with gate 22 and the abutting valve sleeve 40 to prevent leakage of material from knife gate valve assembly 10. The improved hardness and resilience also allow seat portion 46 of valve sleeve 40 to move with relative ease in response to the reciprocating movement of gate 22, thereby prolonging the life of valve sleeve 40. While valve sleeves formed of conventional materials routinely fail after about 6,000 strokes, tests of the valve sleeve according to the principles described herein showed that the life of valve sleeve 40 exceeded 14,000 strokes.

According to the present embodiment, valve sleeve 40 or 140 may be formed of a cast polyurethane material that is the product of a part-A component cured with a part-B component in a two-component polyurethane system. As will be described below in more detail, the part-A component may be an isocyanate prepolymer comprising the reaction product of a diisocyanate and a polyether polyol, and the part-B component may be a curative comprising a diol and/or a diamine chain extender.

The part-A component may comprise an isocyanate prepolymer that is the reaction product of a diisocyanate and a polyether polyol. The diisocyanate may comprise an aromatic diisocyanate, such as toluene diisocyanate (TDI), diphenylmethane diisocyanate, whether pure or modified, and any of their isomers and oligomers, or an aliphatic diisocyanate, such as hexamethylene diisocyanate (HDI), methylene dicyclohexyl diisocyanate or hydrogenated MDI (HMDI) and isophorone diisocyanate (IPDI). Preferably, the diisocyanate comprises one or more of 4,4′-diphenylmethane diisocyanate (also known as methylene-4,4′-diphenyl diisocyanate, or MDI), 2,2′-diphenylmethane diisocyanate, 2,4′-diphenylmethane diisocyanate, pure MDI, polymeric diphenylmethane diisocyanate (PMDI), oligomers of PMDI, and blends thereof.

The polyether polyol component may comprise a polyether polyol having a molecular weight of 1,000 Da or more. For example, the polyether polyol may include, but is not limited to, polyether glycols derived from ethylene oxide, propylene oxide, and butylene oxide, and blends thereof. Preferably, the polyether polyol comprises one or more of polyethylene glycol (PEG), polypropylene glycol (PPG), poly(tetramethylene ether) glycol (PTMEG), derivatives of PEG, PPG, or PTMEG, and blends thereof. More preferably, the polyether polyol comprises PTMEG.

To form the part-A isocyanate prepolymer, an excess of the diisocyanate is reacted with the polyether polyol. In this reaction, a hydroxyl group of the polyol reacts with the isocyanate group (NCO) of the diisocyanate in an addition reaction to form the isocyanate prepolymer. In theory, because an excess of diisocyanate is used, all of the hydroxyl groups of the polyol react, leaving the excess unreacted isocyanate groups at the terminal ends of the resulting isocyanate prepolymer. The free reactive NCO content is a measure of the weight percent of unreacted isocyanate groups in the part-A component isocyanate prepolymer. According to the present embodiment, the part-A component isocyanate prepolymer may have free reactive NCO content ranging from about 5% to about 24%, preferably from about 10% to about 20%, more preferably from about 13% to about 16%, and even more preferably from about 14% to about 15%. In one embodiment, the free reactive NCO content may be approximately 14.5%. The part-A component isocyanate prepolymer may have an equivalent weight ranging from approximately 280 up to approximately 300, preferably approximately 290.

The part-A component isocyanate prepolymers may then be linked together by reacting with the free reactive isocyanate (NCO) groups with the part-B component curative to form a polymer chain having urethane linkages. The part-B component curative may comprise one or more chain extenders that link the isocyanate prepolymer molecules together in a polymer reaction to form a polymer. The curative may comprise a low-molecular weight diol or polyol having terminal hydroxyl groups that react with the free reactive isocyanate groups of the part-A component isocyanate prepolymer. When the part-A prepolymer component is formed of MDI and MDI derivatives, the curative preferably comprises low molecular weight diols and polyols, but may also include amine chain extenders and hybrids of amine and polyol chain extenders.

Examples of the part-B component curative may include, but are not limited to, water, ethylene glycol, 1,4-butanediol; 1,2-propylene glycol, 1,3-propanediol; diethylene glycol, noepentyl glycol, 1,6-hexanediol, cyclohexane dimethanol, hydroquinone bis(2-hydroxyethyl) ether; resorcinol bis(2-hydroxyethyl ether); bisphenol A bis(2,3-dihydroxypropyl) ether; 4,4′-methylene-bis(ortho-chloroaniline) (MOCA); glycerine; 2-methyl-1,3-propanediol; trimethylolpropane; methylene bis(2,6-diethyl-3-chloroaniline); 1,6-hexane diamine; 1,3-diamine pentane; diethanolamine; triethanolamine; 3,5-diethytoluene-2,4-diamine; 3,5-diethytoluene-2,6-diamine; dimethylthiotoluenediamine; p-aminobenzoate ester of PTMEG 1000; methylene bis(ortho-ethylaniline); and sodium chloride complex of methylene-bis-aniline. Preferably, the part-B component may comprise an aliphatic diol or an aromatic diol. More preferably, the part-B component comprises 1,4-butanediol. The part-B component curative may also include any of the above listed chain extenders blended with polyether polyols having a molecular weight of 200 Da or higher.

The part-B component may further include one or more catalysts to catalyze the polymerization reaction of the chain extender with the part-A component isocyanate prepolymer. Suitable catalysts may include, but are not limited to, Lewis acid transition metals and tertiary amines, such as triethylene diamine (TEDA), dibutylin dilaurate (T-12), 1,8-diazabicyclo (5,4,0) undec-7-ene (DBU), bis(dimethylaminoethyl) ether, pentamethyl diethylenetriamine, pentamethyledipropylenetriamine, tin (II) 2-ethylhexanoate (T-9), dibutyltindimereaptide (UL-22), and dimethylpiperazine.

Additives that may be added to the part-A component or part-B component may include, but are not limited to, flame retardants, such as fluorine, chlorine, bromine or iodine compounds; pigments; and fillers, such as calcium carbonate, and glass fibers.

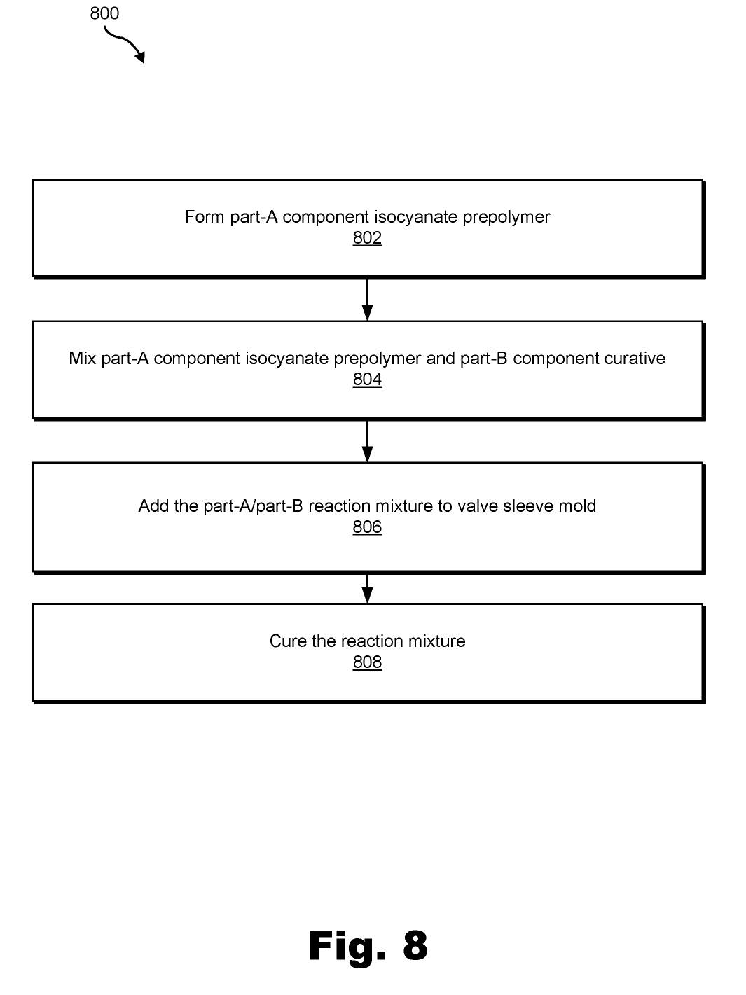

An exemplary method 800 of making a valve sleeve formed with the polyurethane material described herein will now be described with reference to FIG. 8. In step 802, the part-A component isocyanate prepolymer is formed separately from the part-B component curative. As previously explained, an excess of the diisocyanate, such as MDI, is reacted with the polyether polyol, such as PTMEG, such that the part-A component isocyanate prepolymer has free reactive NCO content ranging from about 5% to about 24%, preferably from about 10% to about 20%, more preferably from about 13% to about 16%, and even more preferably from about 14% to about 15%. In one embodiment, the free reactive NCO content may be approximately 14.5%.

In step 804, a polyurethane reaction mixture is formed by mixing the part-A component isocyanate prepolymer and the part-B component curative at a stoichiometric ratio of NCO:OH ranging from approximately 100:70 by weight up to about 100:100 by weight, plus or minus about 5%. In the mixing step, the part-A component isocyanate prepolymer may be added at an ambient temperature ranging from about 70° F. to about 90° F., and the part-B component curative may be added at a temperature of about 90° F. to about 110° F.

Because the reaction occurs quickly, in step 806 the reaction mixture comprising the part-A component isocyanate prepolymer and the part-B component curative may be poured or injected into a valve sleeve mold soon after mixing. The reaction mixture may then be cured in step 808. Preferably, the temperature under which the reaction takes places ranges from about 70° F. to about 200° F., preferably from about 70° F. to about 120° F. The mold temperature may range from about 100° F. to about 120° F. Under these conditions the part-A component isocyanate prepolymer and the part-B component curative undergo the urethane reaction until the mixture fully cures.

The polyurethane formulation for valve sleeve 40 of the present embodiment has a Shore A hardness ranging from about 50 to about 80 durometer, preferably from about 60 to about 75 durometer, and more preferably from about 65 to about 70 durometer.

Additionally, the polyurethane formulation for valve sleeve 40 of the present embodiment has improved resilience, having a Bashore (aka Bayshore) rebound ranging from about 30% to about 60%, preferably from about 40% to about 55%, and more preferably from about 45% to about 50%. In one embodiment, the Bashore rebound of the polyurethane formulation is approximately 47%.

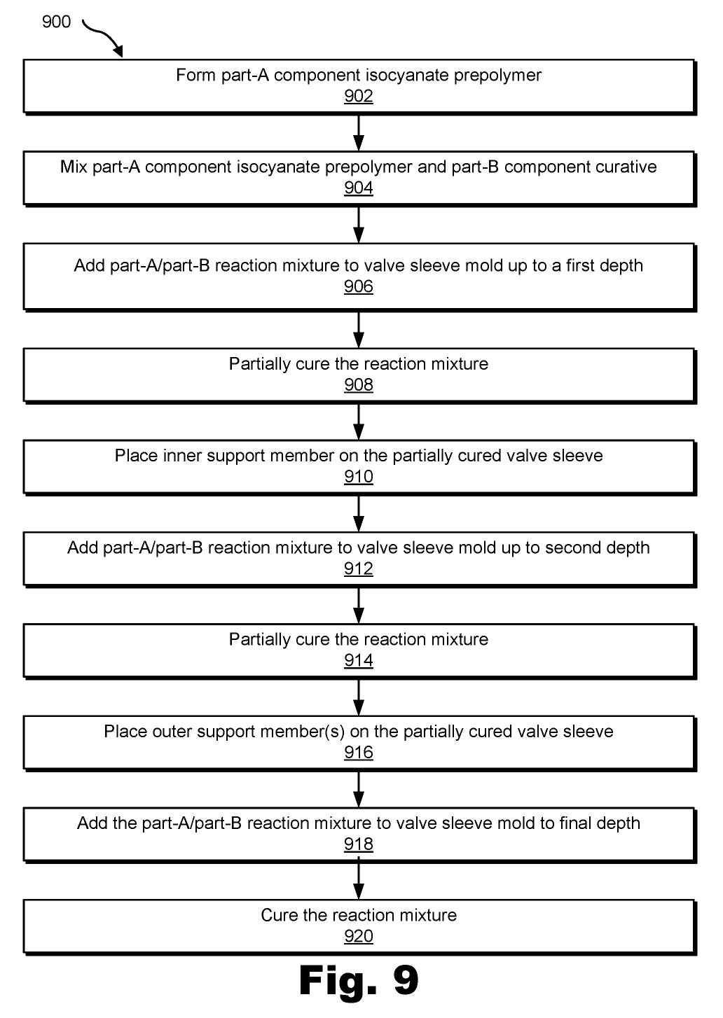

As explained above, one or more support members may be disposed within valve sleeve 40 or 140. To form a valve sleeve 40 or 140 with a support member, such as inner support member 60, outer support member 70, and/or outer support members 80, the molding process may be carried out in stages. FIG. 9 depicts an exemplary method 900 of forming a valve sleeve including one or more support members.

In step 902, the part-A component isocyanate prepolymer is formed separately from the part-B component curative. Step 902 may be performed in any of the ways described herein.

In step 904, a polyurethane reaction mixture is formed by mixing the part-A component isocyanate prepolymer and the part-B component curative. Step 904 may be performed in any of the ways described herein.

In step 906, the polyurethane reaction mixture is poured or injected into a valve sleeve mold up to a first depth at which an inner support member will be positioned within the valve sleeve.

In step 908, the polyurethane reaction mixture is allowed to partially cure until it is strong enough to support the weight of the inner support member.

In step 910, the inner support member is set in position on the first stage of the partially cured polyurethane reaction mixture.

In step 912, the polyurethane reaction mixture is poured or injected into the valve sleeve mold covering the first stage of the partially cured polyurethane reaction mixture and the inner support member up to a second depth at which an outer support member will be positioned within the valve sleeve.

In step 914, the polyurethane reaction mixture is allowed to partially cure until it is strong enough to support the weight of the outer support member.

In step 916, the outer support member or plurality of support members is set in position on the second stage of the partially cured polyurethane reaction mixture.

In step 918, the polyurethane reaction mixture is poured or injected into the valve sleeve mold covering the second stage of the partially cured polyurethane reaction mixture and the outer support member. If no further support members are added, the polyurethane reaction mixture is added up to the final depth of the mold. Additional support members may be added by repeating any of the steps 906-914. In step 920, the polyurethane reaction mixture is then allowed to cure until the reaction of the part-A component isocyanate prepolymer with the part-B component curative is complete.

In some embodiments, any one or more of inner support member 60, outer support member 70, and outer support members 80 may undergo a surface treatment to improve adhesion and bonding to the polyurethane material. For example, prior to adding outer support member to the second stage of the partially cured polyurethane reaction product, the surface treatment may comprise providing a coarse angular surface profile to increase the total surface area for adhesive bonding to the polyurethane material of valve sleeve 140. This may be done, for example, by a sand blasting process for a near-white finish (e.g., in accordance with NACE #2/SSPC 10-63 specifications promulgated by NACE International).

Additionally or alternatively, the surface treatment may comprise applying a primer coating formulated for bonding polyurethane to metal. The primer may be applied by brush, dip, or spray. Preferably, the dry film thickness of primer on the inner support member and/or outer support member comprises approximately 2.5 micron (μ).

As explained above, resulting elastomeric valve sleeve formed of the cast polyurethane material described herein has improved wear resistance, hardness, and resilience, and thus has improved longevity, as compared with conventional valve sleeves. For example, the combination of hardness and resilience of the cast polyurethane material described herein facilitates movement of the valve sleeve when the gate opens and closes, and also improves the abrasion resistance of the valve sleeves to materials and fluids that pass through the channel of the valve sleeve. Thus, the valve sleeves described herein are less prone to abrasion, tearing, ripping, and cutting. Additionally, the valve sleeve formed of the cast polyurethane material described herein is able to rebound and maintain a tight seal between abutting valve sleeves and between the valve sleeve and the gate. In addition, the cast polyurethane material described herein exhibits improved hydrolytic stability improved resistance to mild acids and basis, as compared with the elastomers used in conventional valve sleeves, thus extending the life of valve sleeves, particularly in slurry applications.

In addition to forming the valve sleeve with the above-described cast polyurethane material, any one or more additional components of a knife gate valve assembly may also be formed of the cast polyurethane material. For example, retainer flange 32, wiper 34, and any one or more other seals or gaskets may also be formed of the cast polyurethane material described herein.

Additionally, in the preceding description, the various exemplary embodiments have been described with reference to a knife gate valve assembly. However, the principles described herein are not limited to a knife gate valve assembly, but may be used in any type of valve assembly where a valve sleeve, seat ring, or the like is to be used. For example, the valve sleeves described herein may be used in any type of reciprocating gate valve, such as a slab gate valve, an expanding gate valve, and a wedge gate valve.

In the preceding description, various exemplary embodiments have been described with reference to the accompanying drawings. However, various modifications and changes may be made thereto, and additional embodiments may be implemented, without departing from the scope of the claims set forth below. For example, certain features of one embodiment described herein may be combined with or substituted for features of another embodiment described herein. The description and drawings are accordingly to be regarded in an illustrative rather than a restrictive sense.

What is claimed is:

1. A valve sleeve for sealing a gate valve, comprising:
a sleeve body including:
a seat portion provided at an inner portion of the valve sleeve,
a flange portion provided at an outer portion of the valve sleeve,
a wall portion provided between the seat portion and the flange portion, and
a channel defined by an inside surface of the seat portion, the flange portion, and the wall portion,
wherein
the sleeve body is formed of a cast polyurethane material comprising a product of a part-A component isocyanate prepolymer cured with a part-B component curative,
the part-A component isocyanate prepolymer comprises a reaction product of a diisocyanate with a polyether polyol, the part-A component isocyanate prepolymer having free reactive NCO content ranging from approximately 13% to approximately 16% by weight,
the part-B component curative comprises one or more of a glycol and a diamine extender,
the cast polyurethane material has a Shore A hardness ranging from about 50 to about 80 durometer, and
the cast polyurethane material has a resilience of approximately 30% to approximately 60%, as measured with a Bashore rebound test.

2. The valve sleeve of claim 1, wherein the diisocyanate comprises at least one of 4,4′-diphenylmethane diisocyanate, 2,2′-diphenylmethane diisocyanate, 2,4′-diphenylmethane diisocyanate, polymeric diphenylmethane diisocyanate, and an oligomer of polymeric diphenylmethane diisocyanate.

3. The valve sleeve of claim 1, wherein the polyether polyol has a molecular weight of at least approximately 1,000 Da.

4. The valve sleeve of claim 3, wherein the polyether polyol comprises at least one of polyethylene glycol, polypropylene glycol, and poly(tetramethylene ether) glycol.

5. The valve sleeve of claim 1, wherein the part-A component isocyanate prepolymer comprises free reactive NCO content ranging from approximately 14% to approximately 15% by weight.

6. The valve sleeve of claim 1, wherein the cast polyurethane material has a Shore A hardness ranging from about 60 to about 75 durometer.

7. The valve sleeve of claim 1, wherein the cast polyurethane material has a Shore A hardness ranging from about 65 to about 70 durometer.

8. The valve sleeve of claim 1, wherein the cast polyurethane material has a resilience of approximately 40% to approximately 55%, as measured with the Bashore rebound test.

9. The valve sleeve of claim 3, wherein the cast polyurethane material has a resilience of approximately 45% to approximately 50%, as measured with the Bashore rebound test.

10. The valve sleeve of claim 1, wherein the part-B component curative comprises 1,4-butanediol.

11. The valve sleeve of claim 1, wherein the part-B component curative further comprises a polyether polyol blended with 1,4-butanediol, the polyether polyol having a molecular weight of at least 200 Da.

12. The valve sleeve of claim 1, wherein a stoichiometric ratio of the free reactive NCO content of the part-A component isocyanate prepolymer to reactive hydroxyl (—OH) content of the part-B component curative ranges from approximately 105:70 to approximately 100:100.

13. The valve sleeve of claim 1, wherein the stoichiometric ratio of the free reactive NCO content of the part-A component isocyanate prepolymer to the reactive hydroxyl (—OH) content of the part-B component curative ranges from approximately 105:95 to approximately 100:100.

14. The valve sleeve of claim 1, further comprising:
an inner support member, and
at least one outer support member disposed in an outer portion side of the inner support member and defining an opening corresponding to the channel.

15. The valve sleeve of claim 14, wherein at least one of an outside edge and an inside edge of the outer support member has a shape different than a shape of the valve sleeve, as viewed in an axial direction of the channel.

16. The valve sleeve of claim 14, wherein
the at least one outer support member comprises a plurality of outer support members arranged around the channel so as to define an opening corresponding to the channel, and
the plurality of outer support members are separated from one another by one or more gaps.

17. The valve sleeve of claim 14, wherein a thickness of the at least one outer support member is at least approximately three-sixteenths ( 3/16) of an inch.

18. The valve sleeve of claim 14, wherein
the flange portion includes a flange shelf portion that is substantially orthogonal to an axial direction of the channel,
the at least one outer support member is disposed in the flange portion of the valve sleeve and is at least partially overlapped by the flange shelf portion, and
the at least one outer support member is positioned closer to the flange shelf portion than to an end face of the valve sleeve on an outer portion of the valve sleeve.

19. A valve sleeve for sealing a gate valve, comprising:
an annular sleeve body including:
a seat portion provided at an inner portion of the valve sleeve,
a gasket portion provided at an outer portion of the valve sleeve and having an outside diameter larger than an outside diameter of the seat portion,
a flange portion provided between the seat portion and the gasket portion and having an outside diameter larger than the outside diameter of the seat portion and smaller than the outside diameter of the gasket portion,
a wall portion provided between the seat portion and the flange portion, and
a channel defined by an inside surface of the seat portion, the wall portion, the flange portion, and the gasket portion;
an inner support member disposed in the seat portion or the wall portion; and
at least one outer support member disposed in the flange portion and defining an opening corresponding to the channel,
wherein
the sleeve body is formed of a cast polyurethane material comprising a product of a part-A component isocyanate prepolymer cured with a part-B component curative,
the part-A component isocyanate prepolymer comprises a reaction product of a diisocyanate with a polyether polyol and has free reactive NCO content ranging from approximately 13% to approximately 16% by weight,
the diisocyanate comprises one or more of 4,4′-diphenylmethane diisocyanate, 2,2′-diphenylmethane diisocyanate, 2,4′-diphenylmethane diisocyanate, polymeric diphenylmethane diisocyanate, and an oligomer of polymeric diphenylmethane diisocyanate,
the part-B component curative comprises 1,4-butanediol,
the cast polyurethane material has a Shore A hardness ranging from about 65 to about 70 durometer, and
the cast polyurethane material has a resilience of approximately 45% to approximately 50%, as measured with a Bashore rebound test.

20. A gate valve assembly, comprising:
a valve sleeve configured to be inserted in a sleeve channel of a housing of a gate valve, the valve sleeve comprising:
a seat portion provided at an inner portion of the valve sleeve and configured to sit against a gate of the gate valve when the gate is in a closed position,
a flange portion provided at an outer portion of the valve sleeve,
a wall portion provided between the seat portion and the flange portion, and
a channel defined by an inside surface of the seat portion, the wall portion, and the flange portion;
a wiper configured to wipe the gate during movement of the gate; and
a retainer flange provided at an end face of the flange portion,
wherein
the valve sleeve, the wiper, and the retainer flange are formed of a cast polyurethane material comprising a product of a part-A component isocyanate prepolymer cured with a part-B component curative,
the part-A component isocyanate prepolymer comprises a reaction product of a diisocyanate with a polyether polyol, the isocyanate prepolymer having free reactive NCO content ranging from approximately 13% to approximately 16% by weight,
the part-B component curative comprises one or more of a glycol and a diamine extender,
the cast polyurethane material has a Shore A hardness ranging from about 50 to about 80 durometer,
the cast polyurethane material has a resilience of approximately 30% to approximately 60%, as measured with a Bashore rebound test, and
the retainer flange is formed of the cast polyurethane material.
